(19) United States
(12) Patent Application Publication
(10) Pub. No.: US 2021/0340919 A1
(43) Pub. Date: Nov. 4, 2021

(54) THROTTLE DEVICE

(71) Applicant: MIKUNI CORPORATION, Tokyo (JP)

(72) Inventors: Jun KIYONO, Odawara-shi (JP); Naoki TANAKA, Odawara-shi (JP)

(21) Appl. No.: 17/188,131

(22) Filed: Mar. 1, 2021

(30) Foreign Application Priority Data
May 1, 2020 (JP) 2020-081161

(51) Int. Cl. F02D 9/10; F02M 61/14

(52) U.S. Cl. CPC F02D 9/1065; F02M 61/14

(57) ABSTRACT

A throttle device 1 includes a throttle valve 2, and a throttle body 6 having a through hole 4 where the throttle valve 2 is arranged, the throttle body 6 including a connection part 28 to which a flow passage forming member 26 is finable, the flow passage forming member 26 communicating with the through hole 4 and forming an intake passage 3 with the through hole 4, and the connection part 28 having a contour 50 defined by a minor axis L1 along an axis direction of a rotatable shaft 12 of the throttle valve 2 and a major axis L2 which is longer than the minor axis L1.

### TECHNICAL FIELD

The present disclosure relates to a throttle device.

### BACKGROUND

Conventionally, an engine mounted on a vehicle such as a two-wheeled vehicle or a four-wheeled vehicle may be provided with a throttle device for adjusting the amount of intake air supplied to the engine. A typical throttle device includes a throttle valve and a throttle body for housing the throttle valve. Moreover, the throttle body includes a connection part (that is, a mounting clasp or a spigot) to which a flow passage forming member (for example, a rubber joint) for forming a part of an intake passage toward the engine is fitted. For example, Patent Document 1 discloses a throttle body where a pair of mounting clasps (spigots) positioned on both sides of a connection synchronization mechanism are decentered with respect to the center of the intake passage so as to be separated from each other.

### CITATION LIST

### Patent Literature

Patent Document 1: JP2008-286098A

### SUMMARY

Meanwhile, in order to mount the flow passage forming member on the connection part of the throttle device, a space for the flow passage forming member to be fitted to the connection part is needed. In this regard, in the throttle body described in Patent Document 1, since the configuration is adopted in which the connection part (mounting clasps) is decentered with respect to the center of the intake passage, the space for the flow passage forming member to be fitted to the connection part is ensured easily, whereas a width dimension of the throttle device is increased due to decentering of the connection part. The increase in width dimension of the throttle device may become a cause of an increase in weight of the throttle device or an interference with a peripheral equipment of the throttle device such as a harness.

The present disclosure was made in view of the above, and an object of the present disclosure is to provide a throttle device capable of achieving a reduction in size/weight while maintaining mountability of the flow passage forming member on the connection part of the throttle device.

(1) A throttle device according to at least one embodiment of the present disclosure includes a throttle valve, and a throttle body having a through hole where the throttle valve is arranged, the throttle body including a connection part to which a flow passage forming member is finable, the flow passage forming member communicating with the through hole and forming an intake passage with the through hole, and the connection part having a contour defined by a minor axis along an axis direction of a rotatable shaft of the throttle valve and a major axis which is longer than the minor axis.

(2) In some embodiments, in the above configuration (1), the throttle device may further include a gear casing for housing a gear configured to operate simultaneously with the rotatable shaft of the throttle valve. The gear casing may be arranged away from the connection part in the axis direction so as to face a region of the contour of the connection part including an intersection of the contour and the minor axis.

(3) In some embodiments, in the above configuration (2), provided that half a length of the major axis of the contour of the connection part is Rmax, a thickness of the flow passage forming member is a, and a distance between the gear casing and a center of the contour of the connection part is d, d<Rmax+a+5 mm may be satisfied.

(4) In some embodiments, in the above configuration (2), the gear casing may protrude to an opposite side to the throttle valve relative to an end surface of the connection part where an opening end of the through hole is formed, in an extending direction of the through hole.

(5) In some embodiments, in the above configuration (1), the throttle device may further include a fuel injection device held by the connection part to be exposed to the intake passage. The fuel injection device may be arranged at a position deviated from the through hole in an extending direction of the major axis.

(6) In some embodiments, in the above configuration (1), the through hole may be circular.

(7) In some embodiments, in the above configuration (1), the connection part may have a groove, to which the flow passage forming member is finable, in an outer circumferential surface of the connection part defined by the contour of the connection part.

According to at least one embodiment of the present disclosure, it is possible to provide a throttle device capable of achieving a reduction in size/weight while ensuring mountability on an engine.

### BRIEF DESCRIPTION OF DRAWINGS

FIG. 1 is a perspective view showing the configuration of a throttle device according to an embodiment of the present disclosure.

FIG. 2 is a view schematically showing the internal configuration of a gear casing according to an embodiment of the present disclosure.

FIG. 3 is a schematic view showing the configuration of a connection part according to an embodiment of the present disclosure.

FIG. 4 is an explanatory view for describing the configuration of a contour of the connection part according to an embodiment of the present disclosure, where the connection part is viewed from a side of a cylinder of an engine.

FIG. 5 is an explanatory view for describing the configuration of the contour of the connection part according to an embodiment of the present disclosure, where the connection part is viewed from the side of the cylinder of the engine.

### DETAILED DESCRIPTION

An embodiment of the present disclosure will now be described with reference to the accompanying drawings. It is intended, however, that unless particularly identified, dimensions, materials, shapes, relative positions and the like of components described or shown in the drawings as the embodiments shall be interpreted as illustrative only and not intended to limit the scope of the present invention.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same”, “equal”, and “uniform” shall not be construed as indicating only the state in which the feature is strictly equal, but also includes a state in which there is a tolerance or a difference that can still achieve the same function.

Further, for instance, an expression of a shape such as a rectangular shape or a tubular shape shall not be construed as only the geometrically strict shape, but also includes a shape with unevenness or chamfered corners within the range in which the same effect can be achieved.

On the other hand, the expressions “comprising”, “including”, “having”, “containing”, and “constituting” one constituent component are not exclusive expressions that exclude the presence of other constituent components.

(Configuration of Throttle Device)

The configuration of a throttle device according to an embodiment of the present disclosure will be described. The throttle device is mounted on an intake side of a multi-cylinder engine (not shown) mounted on a two-wheeled vehicle so as to adjust the amount of intake air flowing into the multi-cylinder engine, for example. In the present disclosure, a description will be given by taking a throttle device, which is mounted on an engine having two cylinders, as an example.

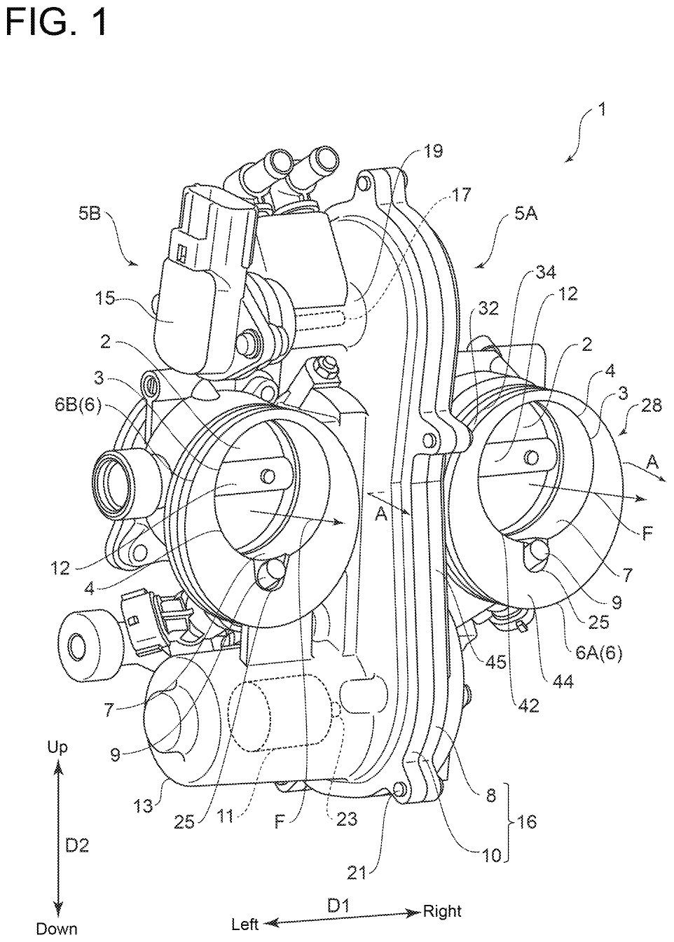

FIG. 1 is a perspective view showing the configuration of a throttle device 1 according to an embodiment of the present disclosure. As shown in FIG. 1, the throttle device 1 includes throttle valves 2 and throttle bodies 6 each having a through hole 4 where a corresponding one of the throttle valves 2 is arranged. The through hole 4 penetrates a corresponding one of the throttle bodies 6 so as to have a true circular cross-sectional shape, and functions as a part of an intake passage 3 where intake air F supplied to an engine flows. In some embodiments, the through hole 4 is a circular hole having a predetermined radius. In another embodiment (not shown), the through hole 4 may have an elliptical shape. Moreover, in another embodiment (not shown), in the intake passage 3, upstream of the through hole 4 in a flow direction of the intake air F, an air cleaner for filtering the intake air F may be provided.

In the exemplary form shown in FIG. 1, in a wall part 7 defining the through hole 4 of the corresponding one of the throttle bodies 6, a hole 25 where a fuel injection device 9 is inserted is formed. The fuel injection device 9 inserted into and fixed to the hole 25 of the wall part 7 of the throttle body 6 is exposed to the intake passage 3 and is configured to be able to inject a fuel into the intake passage 3 in response to an electric signal from an ECU (not shown). At a downstream end portion of the throttle body 6 in the flow direction of the intake air F, a tubular connection part 28 is formed. The detailed configuration of the connection part 28 will be described later. In an example shown in FIG. 1, the fuel injection device 9 is exposed to the intake passage 3, downstream of the throttle valve 2 in the flow direction of the intake air F. Thus, the fuel from the fuel injection device 9 is injected downstream of the throttle valve 2 of the intake passage 3.

In the present embodiment, the throttle device 1 includes a right-hand casing 5A and a left-hand casing 5B disposed in an axis direction (to be referred to as a “first direction D1”, hereinafter) of rotatable shafts 12 of the throttle valves 2, respectively. In the present disclosure, one side of the first direction D1 will be referred to as “right”, and the other side of the first direction D1 will be referred to as “left”. In the first direction D1, the right-hand casing 5A is positioned to the right of the left-hand casing 5B.

The right-hand casing 5A includes a first throttle body 6A (6). The left-hand casing 5B includes a second throttle body 6B (6) positioned to the left of the first throttle body 6A, a motor casing 13 for housing a motor 11, and a shaft casing 19 for housing a shaft 17 connected to a position sensor 15. The motor casing 13 is positioned opposite to the shaft casing 19 across the second throttle body 6B in a second direction D2. The second direction D2 is a direction, of a direction orthogonal to the first direction D1, in which with reference to the rotatable shafts 12 of the throttle valves 2, one side where the fuel injection device 9 is arranged will be referred to as “down”, and the other side which is an opposite direction to the one side will be referred to as “up”. That is, in the present disclosure, if the first direction D1 is a “right-left direction”, the second direction D2 is an “up-down direction” accordingly. In the second direction D2, the motor casing 13 is positioned below the second throttle body 6B, and the shaft casing 19 is positioned above the second throttle body 6B. In another embodiment (not shown), the position sensor 15 may be arranged to be coupled to the rotatable shaft 12 of the throttle valve 2. Moreover, in another embodiment (not shown), in the second direction D2, the motor casing 13 may be positioned above the second throttle body 6B. In this case, the fuel injection device 9 is positioned opposite to the motor casing 13 across the through hole 4 in the second direction D2.

Moreover, in the exemplary embodiment shown in FIG. 1, a left end portion 8 on the left side of the right-hand casing 5A and a right end portion 10 on the right side of the left-hand casing 5B are coupled to each other by fasteners 21 such as bolts. Although not shown in FIG. 1, surrounded by the left end portion 8 of the right-hand casing 5A and the right end portion 10 of the left-hand casing 5B, a gear storage space 18 is formed.

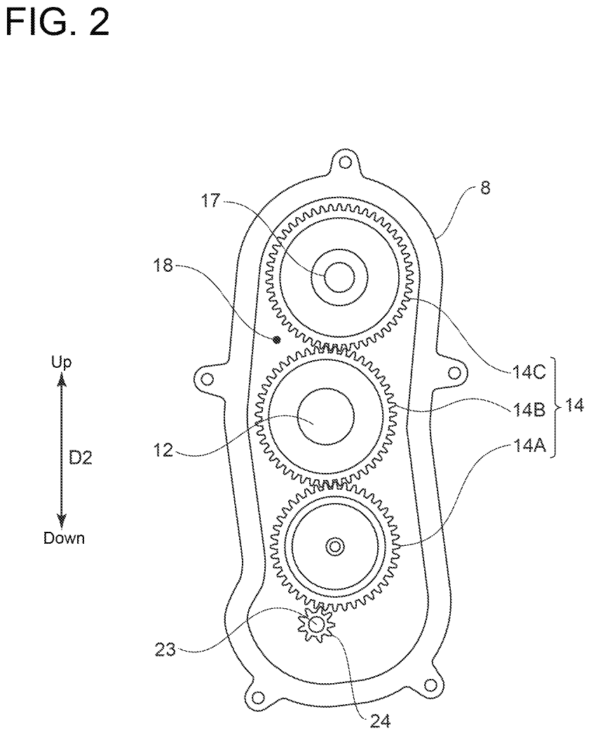

FIG. 2 is a view schematically showing the internal configuration of a gear casing 16 according to an embodiment of the present disclosure. As shown in FIG. 2, in the gear storage space 18, gears 14 configured to operate simultaneously with the rotatable shaft 12 of the throttle valve 2 are stored. That is, the left end portion 8 of the right-hand casing 5A and the right end portion 10 of the left-hand casing 5B constitute the gear casing 16 for housing the gears 14. For the sake of description, the right end portion 10 of the left-hand casing 5B is not shown in FIG. 2.

In the exemplary form shown in FIG. 2, the gear 14 includes a first gear 14A, a second gear 14B, and a third gear 14C. The first gear 14A engages with a motor output gear 24 mounted on an output shaft 23 of the motor 11. The second gear 14B is mounted with the rotatable shaft 12 of the throttle valve 2, allowing the second gear 14B and the rotatable shaft 12 to rotate integrally. Likewise, the third gear 14C is mounted on the shaft 17, allowing the third gear 14C and the shaft 17 to rotate integrally. Moreover, in the second direction D2, the first gear 14A is positioned opposite to the third gear 14C across the second gear 14B. The first gear 14A is positioned below the second gear 14B. Then, the first gear 14A and the second gear 14B engage with each other. Moreover, the third gear 14C is positioned above the second gear 14B. Then, the third gear 14C and the second gear 14B engage with each other. The configuration of the gears 14 is not limited to the example shown in FIG. 2, as long as the gears 14 are configured to operate simultaneously with the rotatable shaft 12 of the throttle valve 2.

The configuration of the throttle device 1 according to an embodiment of the present disclosure will be described below, by taking the first throttle body 6A as an example. However, the present disclosure is not limited to the first throttle body 6A, but is also applicable to the second throttle body 6B.

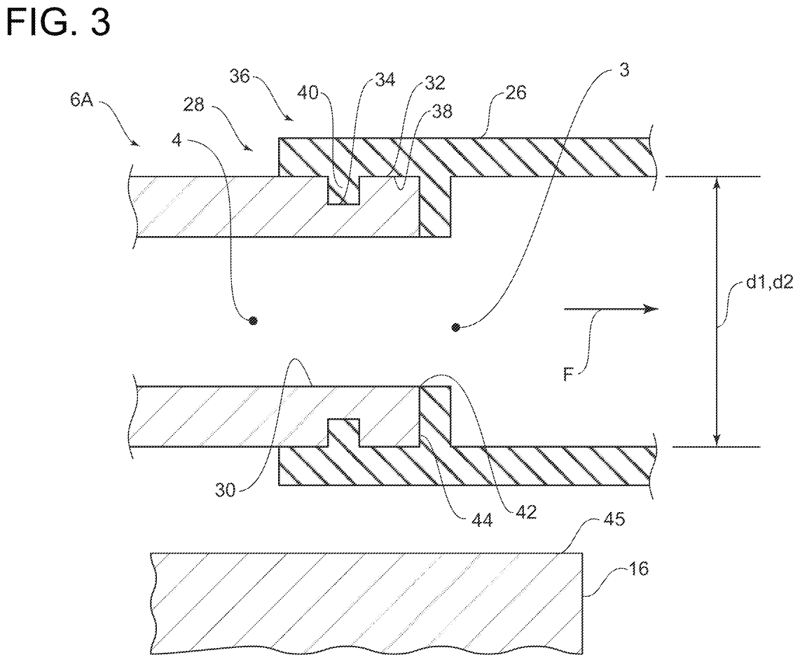

FIG. 3 is a schematic view showing the configuration of the connection part 28 according to an embodiment of the present disclosure. FIG. 3 schematically shows a cross-section taken along a line A-A of FIG. 1, and illustrates a flow passage forming member 26 to be described later. As shown in FIG. 3, the first throttle body 6A includes the connection part 28 where the flow passage forming member 26, which communicates with the through hole 4 and forms the intake passage 3 with the through hole 4, is fittable. In an example shown in FIG. 3, the connection part 28 is formed in a portion of the first throttle body 6A where an outlet 30 of the through hole 4 is formed. An outer circumferential surface 32 of the connection part 28 includes a groove 34 disposed over the entire circumference of the connection part 28.

The flow passage forming member 26 has a tubular shape. The flow passage forming member 26 is provided to connect the throttle device 1 to the engine and is, for example, a rubber joint formed by a rubber material. Adopting the rubber joint, it is possible to obtain an effect of reducing a vibration of the engine. An upstream end portion 36 of the flow passage forming member 26 upstream in the flow direction of the intake air F is fitted to the connection part 28. In an illustrated exemplary form, an inner diameter d1 of the upstream end portion 36 of the flow passage forming member 26 and an outer diameter d2 of the connection part 28 are substantially the same. Moreover, the flow passage forming member 26 includes a protrusion 40 protruding from an inner peripheral surface 38 of the upstream end portion 36 of the flow passage forming member 26 toward the inside (intake passage 3) of the flow passage forming member 26. Then, the protrusion 40 is fitted to the groove 34 of the connection part 28 described above.

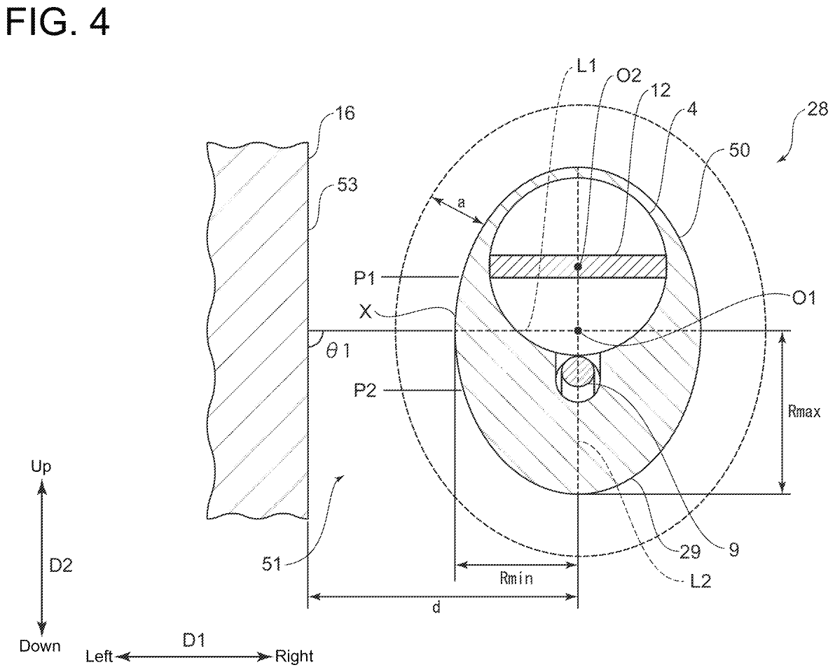

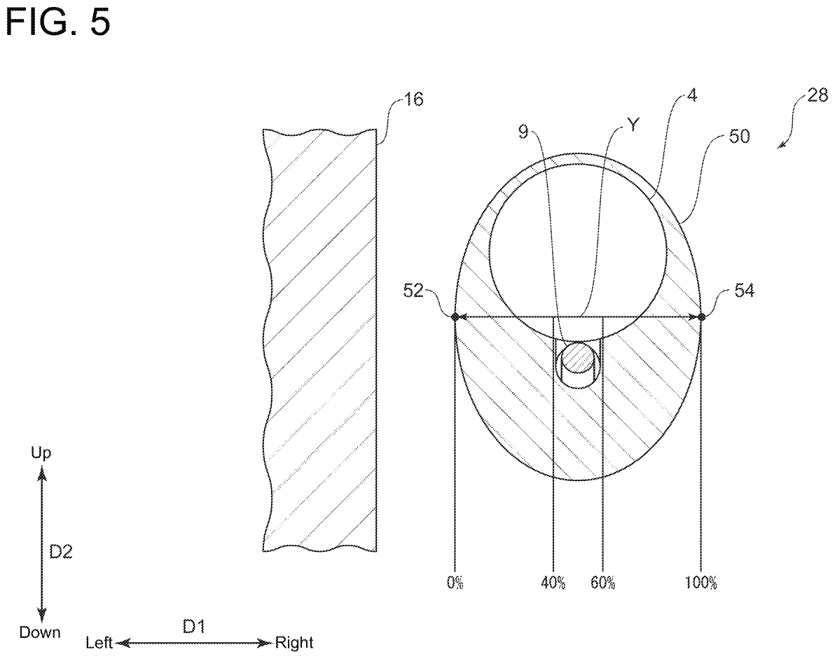

Next, with reference to FIGS. 4 and 5, a contour 50 of the connection part 28 as the first throttle body 6A is viewed downstream in the flow direction of the intake air F will be described. FIGS. 4 and 5 are each an explanatory view for describing the configuration of the contour 50 of the connection part 28 according to an embodiment of the present disclosure, where the connection part 28 is viewed from a side of a cylinder of the engine.

As shown in FIG. 4, the connection part 28 has the contour 50 defined by a minor axis L1 along the first direction D1 of the rotatable shaft 12 of the throttle valve 2 and a major axis L2 which is longer than the minor axis L1. In the present embodiment, the contour 50 of the connection part 28 has an elliptical shape. The minor axis L1 is a straight line passing through a center O1 of the contour 50 of the connection part 28 and extends along the first direction D1 (right-left direction). The major axis L2 is a straight line passing through the center O1 of the contour 50 of the connection part 28 and extends along the second direction D2. The contour 50 is not limited to the elliptical shape but may be, for example, an oval shape such as an egg shape or a track shape as long as the contour 50 is defined by the minor axis L1 and the major axis L2.

Moreover, in the present embodiment, the gear casing 16 is arranged away from the connection part 28 in the first direction D1 so as to face a region X of the contour 50 of the connection part 28 including an intersection of the contour 50 and the minor axis L1. An angle θ1, which is formed by the minor axis L1 with respect to a facing surface 53 of the gear casing 16 facing the connection part 28, is smaller than an angle θ2 formed by the major axis L2 with respect to the facing surface 53 of the gear casing 16. In an example shown in FIG. 4, the minor axis L1 is orthogonal to the facing surface 53 of the gear casing 16, and the major axis L2 is parallel to the facing surface 53 of the gear casing 16, resulting in θ1=90° and θ2=180°.

Moreover, in the present embodiment, provided that half a length (long diameter) of the major axis L2 of the contour 50 of the connection part 28 is Rmax, a thickness of the flow passage forming member 26 is a, and a distance between the gear casing 16 and the center O1 of the contour 50 of the connection part 28 is d, d<Rmax+a+5 mm is satisfied. In the illustrated exemplary form, the thickness of the flow passage forming member 26 has the thickness a over the entire periphery. Moreover, provided that half a length (short diameter) of the minor axis L1 of the contour 50 of the connection part 28 is Rmin, d>Rmin+a+5 mm is satisfied, allowing the flow passage forming member 26 to reliably be fitted to the connection part 28. That is, “5 mm” is a margin needed to fit the flow passage forming member 26 to the connection part 28.

Moreover, in the present embodiment, in the first direction D1, a distance between a position of a center O2 of the through hole 4 and a position of the center O1 of the contour 50 of the connection part 28 is zero. That is, the connection part 28 is not eccentric with respect to the through hole 4 in the first direction D1.

Moreover, in the present embodiment, the fuel injection device 9 is held by the connection part 28. Then, the fuel injection device 9 is arranged at a position deviated from the through hole 4 in an extending direction of the major axis L2. The thickness of the connection part 28 is not constant in the circumferential direction, but is set to be larger in a region 29 where the fuel injection device 9 is disposed than in another region. In order to implement such thickness distribution of the connection part 28, in the form exemplified in FIG. 4, the center O2 of the through hole 4 deviates from the center O1 of the contour 50 in the direction of the major axis L2 on an opposite side to the fuel injection device 9 across the center O1.

With reference to FIG. 5, the position of the fuel injection device 9 will be described. As shown in FIG. 5, a point 52 of the contour 50 of the connection part 28 on the side (left side) of the gear casing 16 is defined as a position at 0% of a length Y of the contour 50 of the connection part 28 in the first direction D1, and another end 54 of the contour 50 of the connection part 28 increasing toward the point 54 of the contour 50 of the connection part 28 on an opposite side (right side) to the side of the gear casing 16 is defined as a position at 100% of the length Y of the contour 50 of the connection part 28 in the first direction D1. In this case, the fuel injection device 9 is positioned within a range at 40% to 60% of the length Y of the contour 50 of the connection part 28 in the first direction D1. The length Y corresponds to the length of the minor axis L1.

Moreover, in the present embodiment, as shown in FIGS. 1 and 3, the gear casing 16 protrudes to the opposite side to the throttle valve 2 relative to an end surface 44 of the connection part 28 where an opening end 42 of the through hole 4 is formed, in the extending direction of the through hole 4.

### Operation/Effect

An operation/effect of the throttle device 1 according to an embodiment of the present disclosure will be described. In order to mount the throttle device 1 on the engine, the flow passage forming member 26 (rubber joint) needs to be fitted to the connection part 28 (spigot). In the conventional throttle device, in order to ensure a fitting space of the rubber joint, the entire length of the connection part is elongated in the flow direction of the intake air. In this method, however, the size and weight of the throttle device may be increased. Moreover, as another method, in the conventional throttle device, the connection part is eccentric in a direction separated from the gear casing. In this method, however, as a width dimension (a dimension in the first direction D1) increases, an increase in weight of the throttle device and an interference with a peripheral equipment of the throttle device such as a harness can be problems.

With the configuration of the throttle device 1 according to an embodiment of the present disclosure, since the contour 50 of the connection part 28 has the shape defined by the minor axis L1 and the major axis L2, it is possible to ensure the fitting space for the flow passage forming member 26 to be fitted to the connection part 28, without elongating the entire length of the connection part 28 in the flow direction of the intake air. Thus, it is possible to achieve a reduction in size/weight while maintaining mountability of the flow passage forming member 26 on the connection part 28 of the throttle device 1.

Moreover, since the connection part 28 is not eccentric with respect to the through hole 4 in the first direction D1, it is possible to suppress the interference of the throttle device 1 with the peripheral equipment of the throttle device 1. In particular, the throttle device 1 according to the present disclosure is advantageous when disposed on a vehicle limited in size in a vehicle width direction, such as a two-wheeled vehicle.

Arranging the gear casing and the connection part in proximity to each other, in the case of the conventional connection part having the circular-shaped contour, it is necessary to ensure a fitting space by reducing the radius of the contour. Meanwhile, since the connection part needs a thickness for holding the fuel injection device, it is impossible to unlimitedly reduce the radius of the contour of the connection part. In this regard, according to the present embodiment, in the case of the conventional connection part having the circular-shaped contour defined by a constant radius with the dimension Rmax of the major axis L2, d<Rmax+a+5 mm holds, making it impossible to ensure a sufficient fitting space, whereas with the contour 50 defined by an ellipse having the minor axis L1 shorter than the major axis L2, it is possible to ensure the fitting space for the flow passage forming member 26 to be fitted to the connection part 28 while ensuring the thickness of the connection part 28 for holding the fuel injection device 9.

Moreover, in the case of the throttle device 1 having the typical configuration, a gap 51 between the gear casing 16 and the connection part 28 is the tightest restriction in ensuring the fitting space of the flow passage forming member 26 with respect to the connection part 28. In this regard, according to the present embodiment, the gear casing 16 is arranged away from the connection part 28 in the first direction D1 so as to face the region X of the contour 50 of the connection part 28 (that is, the region including the intersection of the minor axis L1 and the contour 50). Thus, it is possible to ensure the fitting space for the flow passage forming member 26 to be fitted to the connection part 28, without elongating the entire length of the connection part 28 in the flow direction of the intake air.

In particular, as shown in FIG. 3, in the case in which the gear casing 16 protrudes to the side of the cylinder of the engine relative to the end surface 44 of the connection part 28, it is necessary to ensure a sufficient fitting space between the gear casing 16 and the groove 34 of the connection part 28. In this case as well, as in the present embodiment, adopting the configuration in which the contour 50 of the connection part 28 has the shape defined by the minor axis L1 and the major axis L2, it is possible to ensure the sufficient fitting space and to achieve the reduction in size/weight while maintaining mountability of the flow passage forming member 26 on the connection part 28 of the throttle device 1.

Moreover, according to the present embodiment, the fuel injection device 9 is arranged at the position deviated from the through hole 4 in the extending direction of the major axis L2. Thus, as compared with a case in which the fuel injection device 9 is arranged at a position deviated from the through hole 4 in an extending direction of the minor axis L1, it is possible to ensure the thickness of the connection part 28 for holding the fuel injection device 9, while suppressing an increase in the gap 51 between the gear casing 16 and the connection part 28. Moreover, according to the present embodiment, the present disclosure is applicable to the first throttle body 6A having the circular-shaped through hole 4.

The throttle device according to an embodiment of the present invention has been described above. However, the present invention is not limited the above-described form, and various modifications may be applied as long as they do not depart from the object of the present invention.

In the present embodiment, the throttle device 1 (the throttle device 1 of a so-called sensor motor type) in which the gear casing 16 is positioned between the first throttle body 6A and the second throttle body 6B has exemplarily been described. However, the present disclosure is not limited to the present embodiment. The present disclosure is also applicable to the throttle device 1 (the throttle device 1 of a so-called side motor type) in which the gear casing 16 is positioned to the right of the first throttle body 6A or to the left of the second throttle body 6B.

Moreover, in the present embodiment, the flow passage forming member 26 is provided to connect the throttle device 1 to the engine. However, the present disclosure is not limited to the present embodiment. For example, the flow passage forming member 26 may connect the throttle device 1 to the air cleaner. In some embodiments, the connection part 28 may be formed in a portion of the throttle body 6 where an inlet of the through hole 4 is formed.

Moreover, in the present embodiment, the description has been given by taking the case in which the throttle device 1 is mounted on the engine having the two cylinders as an example. However, the present disclosure is not limited to the present embodiment. In some embodiments, the throttle device 1 is mounted on a multi-cylinder engine having at least three cylinders. Moreover, in this case, each of the connection parts 28 may have the contour 50 defined by the minor axis L1 along the axis direction of the rotatable shaft 12 of the throttle valve 2 and the major axis L2 which is longer than the minor axis L1.

1. A throttle device, comprising:
a throttle valve; and
a throttle body having a through hole where the throttle valve is arranged,
the throttle body including a connection part to which a flow passage forming member is finable, the flow passage forming member communicating with the through hole and forming an intake passage with the through hole, and
the connection part having a contour defined by a minor axis along an axis direction of a rotatable shaft of the throttle valve and a major axis which is longer than the minor axis.

2. The throttle device according to claim 1, further comprising a gear casing for housing a gear configured to operate simultaneously with the rotatable shaft of the throttle valve,
wherein the gear casing is arranged away from the connection part in the axis direction so as to face a region of the contour of the connection part including an intersection of the contour and the minor axis.

3. The throttle device according to claim 2,
wherein, provided that half a length of the major axis of the contour of the connection part is Rmax, a thickness of the flow passage forming member is a, and a distance between the gear casing and a center of the contour of the connection part is d,
d<Rmax+a+5 mm is satisfied.

4. The throttle device according to claim 2,
wherein the gear casing protrudes to an opposite side to the throttle valve relative to an end surface of the connection part where an opening end of the through hole is formed, in an extending direction of the through hole.

5. The throttle device according to claim 1, further comprising a fuel injection device held by the connection part to be exposed to the intake passage,
wherein the fuel injection device is arranged at a position deviated from the through hole in an extending direction of the major axis.

6. The throttle device according to claim 1,
wherein the through hole is circular.

7. The throttle device according to claim 1,
wherein the connection part has a groove, to which the flow passage forming member is finable, in an outer circumferential surface of the connection part defined by the contour of the connection part.
